(19) United States
(12) Patent Application Publication
(10) Pub. No.: US 2023/0237920 A1
(43) Pub. Date: Jul. 27, 2023

(54) AUGMENTED REALITY TRAINING SYSTEM

(71) Applicant: UNVEIL, LLC, Cincinnati, OH (US)

(72) Inventors: Steven Patrick Wolf, Cincinnati, OH (US); John Gerald Hendricks, Cincinnati, OH (US); Jason Todd Van Cleave, Cincinnati, OH (US)

(21) Appl. No.: 18/099,607

(22) Filed: Jan. 20, 2023

Related U.S. Application Data
(60) Provisional application No. 63/302,208, filed on Jan. 24, 2022.

(51) Int. Cl. G09B 5/02

(52) U.S. Cl. CPC G09B 5/02; G09B 23/30

(57) ABSTRACT

An augmented reality training system provides immersive training scenarios, and uses a scenario management engine to assess scenario results and recommend appropriate subsequent scenarios. Scenario results may be assessed based upon comparison to doctrinal methods, expert performance, peer performance, or student past performance. Based upon assessments, a student may be presented with challenge appropriate subsequent scenarios. Determination of the challenge or complexity of scenarios for purposes of such recommendations may be accomplished by determination of an objective complexity or challenge metric that is based upon the results of scenario training across multiple students. One example of such a metric is a Shannon entropy metric, which calculates the unpredictability of a scenario by comparing actions taken during the scenario to a configured depth.

### CROSS-REFERENCE TO RELATED APPLICATIONS

The present application claims the priority of U.S. Provisional Pat. Application Serial No. 63/302,208, filed Jan. 24, 2022, and hereby incorporates the same application herein by reference in its entirety.

### TECHNICAL FIELD

The disclosed technology pertains to a system for providing training simulations that may combined with augmented reality and learning management features.

### BACKGROUND

Training and development of skills in simulations or training environments may be beneficial for students, as such training can often provide a combination of challenge, stress, and activity similar to real-world use of the corresponding skills. As an example, tactical combat casualty care (TCCC) saves soldier lives by focusing on common battlefield injuries such as hemorrhage, obstructed airway, and tension pneumothorax. However, developing TCCC training that supports effective transfer of skills to the battlefield for a broad range of learners is not trivial. One barrier to transfer of skill to the real world is that it is difficult to replicate the psychological and physical stress of combat settings. Acute stress causes physiological changes in humans that can degrade perceptual and cognitive processes. These stressors can narrow attention and degrade decision making. However, learners who perform well on tests of medical skill in the training environment may have difficulty performing the same skills when faced with the stress of combat. The same concept is true for other areas where complex skills and analysis must be performed in high stress situations, such as in various first responder situations (e.g., police, fire, and emergency medical care) and other contexts.

Stress inoculation training (SIT) is designed to introduce stressors in a controlled manner to allow trainees in such situations to learn effective coping strategies. SIT is based on the idea that people can be inoculated against stressful stimuli through careful desensitization in a controlled environment. SIT has been shown to improve psychological health in soldiers, and improve the application of medical care in soldiers. For effective SIT, it may be beneficial to include environment cues that are as realistic as possible before the trainee encounters a stressful situation. To provide effective SIT training, it may be beneficial for simulations to be immersive, with sounds, visual cues, smells, time pressure, and uncertainty. During various types of training, including SIT training, for TCCC or other skills, experiences that are immersive, challenging, and novel may provide benefits as compared to experiences that are predictable or trivial.

### SUMMARY

One implementation of the disclosed technology provides a system for providing immersive training scenarios to a user, the system comprising: a wearable augmented reality viewing device; a computing device comprising a display screen, the computing device being in communication with the wearable augmented reality viewing device; a physical object, the physical object being in communication with the computing device; and one or more markers positioned on a surface of the physical object; wherein the wearable augmented reality viewing device comprises in memory executable instructions for capturing information of a physical image; configuring the training scenarios, wherein the training scenarios include an initial difficulty rating; displaying the physical image on the wearable augmented reality viewing device and on the display screen of the computing device, the physical image presenting one or more virtual critical cues; assessing the user’s results during the training scenarios by comparing the user’s results to an ideal doctrinal or expert-based approach to the training scenarios; and modifying the training scenarios based on the user’s results of the training scenarios.

### BRIEF DESCRIPTION OF THE DRAWINGS

The drawings and detailed description that follow are intended to be merely illustrative and are not intended to limit the scope of the invention as contemplated by the inventors.

FIG. 1 is a schematic diagram of an exemplary system configured to recommend and provide training scenarios.

FIG. 2 is a flowchart of an exemplary set of steps that may be performed to provide a training scenario.

FIG. 3 is a flowchart of an exemplary set of that may be performed to update a training scenario.

FIG. 4A is a schematic diagram of an exemplary smart tool usable to perform an action during a training scenario.

FIG. 4B is a schematic diagram of an exemplary smart tool usable to gather information during a training scenario.

FIG. 4C is a schematic diagram of an exemplary scenario environment usable during a training scenario.

FIG. 5 is a flowchart of an exemplary set of high level steps that may be performed to provide scenario based training.

FIG. 6 is a flowchart of an exemplary set of steps that may be performed to configure a system to provide scenario based training.

FIG. 7 is a flowchart of an exemplary set of steps that may be performed to conduct training during scenario based training.

FIG. 8 is a flowchart of an exemplary set of steps that may be performed to assess and provide recommendations based on conducted training.

FIG. 9A is a flowchart of an exemplary set of steps that may be performed to assess scenario results using a doctrinal approach.

FIG. 9B is a flowchart of an exemplary set of steps that may be performed to assess scenario results using an expert approach.

FIG. 9C is a flowchart of an exemplary set of steps that may be performed to assess scenario results using a peer based approach.

FIG. 9D is a flowchart of an exemplary set of steps that may be performed to assess scenario results using a student’s past results.

FIG. 10A illustrates an exemplary interface for comparing a student timeline to an expert timeline.

FIG. 10B illustrates an exemplary interface for comparing a student gaze dataset to an expert gaze dataset.

FIG. 10C illustrates an alternate exemplary interface for comparing a student timeline to an expert timeline.

FIG. 10D illustrates an exemplary interface for providing results of a scenario.

FIG. 11A illustrates an exemplary student interface.

FIG. 11B illustrates an exemplary instructor interface.

FIG. 11C illustrates an exemplary interface for selecting scenarios based upon a complexity score.

FIG. 12 is a flowchart of an exemplary set of steps that may be performed to determine complexity scores for a plurality of scenarios.

FIG. 13 is a flowchart illustrating a recognition primed decision model.

### DETAILED DESCRIPTION

The inventors have conceived of novel technology that, for the purpose of illustration, is disclosed herein as applied in the context of training simulations and learning management. While the disclosed applications of the inventors’ technology satisfy a long-felt but unmet need in the art of training simulations and learning management, it should be understood that the inventors’ technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

As compared to virtual reality (VR) or other types of virtual training simulation, Augmented reality (AR) offers more flexibility that may be beneficially applied to SIT and other training approaches. By presenting realistic virtual cues superimposed on a physical manikin, the learner has an immersive experience, but is also able to practice medical skills (e.g., applying a tourniquet) using equipment from his/her own medical kit, while seeing real-world visual feedback such as their own arms and hands moving in the expected manner. This augmented reality feedback may be implemented within a training system that provides additional features, such as guided learning and automated creation and selection of appropriate training scenarios.

Features available with the system may include the presentation of virtual patients, or other objects related to the objective of the scenario, that display high-fidelity visual cues that mimic human physiology and respond to user’s actions, and which may be superimposed over physical manikins to deliver training that addresses assessment, decision making, and optimizes skill development and retention. Other training elements designed to improve the transferability of skills training to real world application may include virtual patients that expose learners to photorealistic and auditory cues, olfactory cues that recreate important medical cues and psychological stressors present in the real world (e.g., blood, smoke, toxic gases), and introduction of physiological stressors known to degrade psychomotor skills (increased heart rate and respiratory rate, elevated blood pressure, and increased sweating).

Virtual patients or other objects allow trainees to practice identifying perceptual cues that are difficult to recreate using physical objects alone (e.g., skin tone and mental status changes in a patient, selective spread of smoke or fire in a structure), and may allow trainees to see the outcomes of their decisions in a compressed timeline, which may reinforce mastery of related skills. The controlled introduction of sounds, visual cues, smells, time pressure, and uncertainty combined with biometric data of student performance may allow scenarios to be adapted to varying skill levels, prior to the start of a scenario or in real time, and may also allow the targeted presentation of scenarios that are suitable for a previously displayed skill level.

It should be understood that, while many of the examples described herein may be disclosed in the context of medical training scenarios for the sake of clarity, they are not limited to such applications. Instead, it should be apparent that the described methods, devices, and features may be broadly applied to a variety of training scenarios beyond medical scenarios.

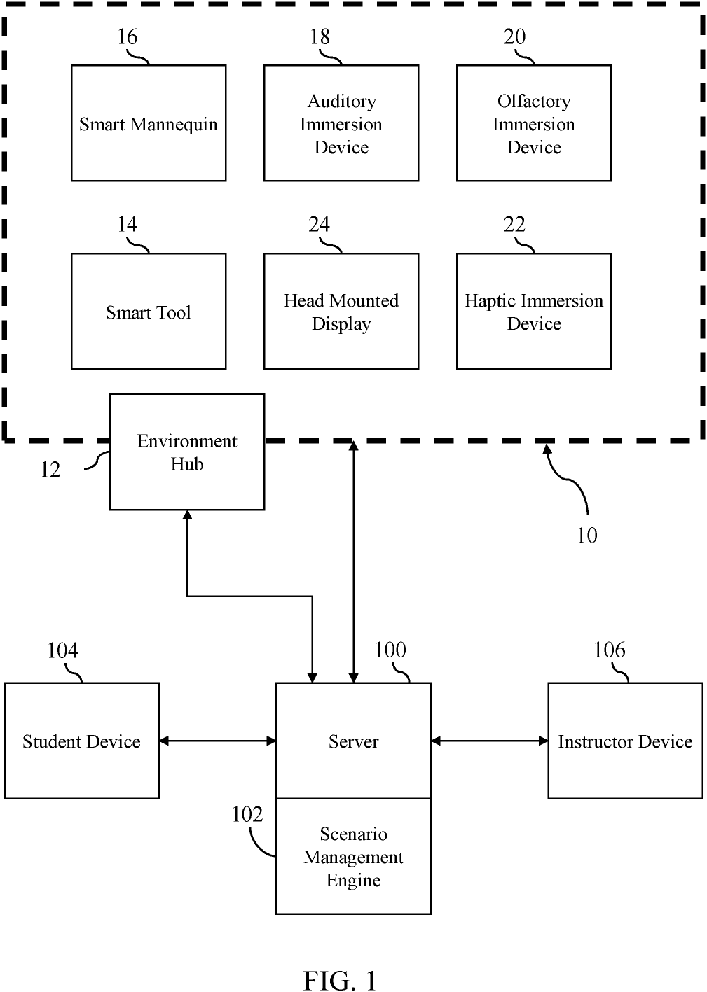

Turning now to the figures, FIG. 1 is a schematic diagram of a training system configured to recommend and provide training scenarios. A server (100) may include one or more physical, virtual, or cloud servers, or other server environments, and may be configured to store, transmit, and manipulate data related to training. The server (100) may also be configured to operate a scenario management engine (SME) (102) that creates and provides data related to training scenarios. In varying implementations, the SME (102) may be configured to dynamically produce scenarios, modify existing scenarios, assess the results of students and others that train with scenarios, recommend subsequent scenarios for training, or all of the above, as will be described in more detail below. The server (100) may also be in communication with a student device (104) configured to allow students to select scenarios and view results, an instructor device (106) configured to allow an instructor to view student results and select scenarios for students to train with. The student device (104) and instructor device (106) may each be a computer, mobile device, tablet, smartphone, or other computing device, or may be a head mounted display (HMD) device having standalone or external capabilities for rendering VR or AR experiences, for example.

The server (100) may also be in communication with one or more devices within a training environment (10), either directly or through an environment hub (12). Communication with the training environment (10) may be via a wired or wireless connection, such as by Wi-Fi, Bluetooth, Ethernet, or USB. In some examples, some or all of the devices of the training environment (10) may be in direct communication with the server (100) via a wireless data connection, while in other examples some or all of the devices may be in direct communication with the server (100) via a wired data connection, or a combination of wireless and wired data connection. The environment hub (12) may be, for example, a networking device such as router, switch, or hub that is configured to communicate with devices in the training environment (10) and provide access (e.g., via a LAN or WAN connection) to the server (100). In some implementations, the environment hub (12) may itself be a computer that is located proximate to the training environment (10), and that is configured to communicate with the devices in the training environment (10) and perform some level of storage, processing, or manipulation of data separately from that provided by the server (100). As an example, the environment hub (12) may receive a scenario dataset that includes visual assets, audio assets, and programming instructions that may be locally executed to conduct a training scenario.

Devices within the training environment (10) will vary by implementation, but may include smart tools (14), smart mannequins (16), auditory immersion devices (18), olfactory immersion devices (20), haptic immersion devices (22), and head mounted displays (HMDs) (24). Smart tools (14) may include devices that are used to perform specific actions or provide specific treatments during a scenario, and may be configured to be rendered within the virtual environment in specific ways, or to provide certain types of feedback or response data depending upon their use during a scenario. As one example, a tourniquet smart tool (14) may include sensors that produce data when the tourniquet is applied to a mannequin that indicates how tightly the tourniquet has been tied. Such data may be used to update the scenario (e.g., where pressure is appropriate, a virtual patient’s condition begins to stabilize) or determine results (e.g., where pressure is appropriate, scenario results may indicate a passing score). Smart tools (14) may include those used to accomplish tasks within the simulation (e.g., a tourniquet or other instrument used to provide a medical treatment), as well as those used to diagnose or gain information during the simulation (e.g., a stethoscope or other instrument used to determine information within the virtual environment).

The smart mannequin (16) may be a physical stand-in for a virtual patient or other object. During the simulation, a student may interact directly with the smart mannequin in an augmented reality view that includes physical touch as well as viewing of virtually overlays that are matched to the smart mannequin. As with smart tools (14), the smart mannequin (16) may include sensors, communication devices, and feedback devices that may be configured to provide data and feedback during scenarios. In varying implementations, smart mannequins (16) and their use within training scenarios may include any of the features described in U.S. Pat. No. 10,438,415, issued Oct. 8, 2019, and titled “Systems and Methods for Mixed Reality Medical Training,” the entire disclosure of which is hereby incorporated by reference herein.

The auditory (18), olfactory (20), and haptic immersion devices (22) may be configured to provide varying types of stimuli during a scenario, based upon signals or instructions provided by the environment hub (12), the server (100), the HMD (24), or another device. The auditory immersion device (18) may include one or more speakers positioned around an area, separately from the HMD (24), and operable to provide sounds related to the simulated scenario, such as a siren sound during a medical scenario, or the sound of burning wood during a fire response scenario. The olfactory immersion device (20) is operable to introduce a scent into the simulation area that relates to the scenario, such as a chemical that simulates the smell of blood during a medical scenario, or the smell of smoke in a fire response scenario. This may include operating a sprayer to spray an amount of a chemical into the air, and may also include operating a fan or other air circulating device to spread the chemical into an area. The haptic immersion device (22) may be integrated with another object, such as the smart mannequin (16) or smart tool (14) and may be operable to simulate a movement, vibration, or other physical response from those objects. In some implementations, the haptic immersion device (22) may be integrated with the training area itself as a platform or pad that the student and smart mannequin (16) or other object are positioned on, and that is operable to provide motion or vibration to simulate a collapsing structure, and earthquake, an explosion, or another condition related to the scenario.

The HMD (24) will vary by implementation, but will generally include a display positioned over the eyes of a wearer, a power source (e.g., a battery or power cable), a communication device (e.g., a wireless communication device or data cable), sensors (e.g., accelerometer, gyroscope), image capture devices usable to capture images of the physical environment for room tracking, hand tracking, controller tracking, object tracking, or augmentation, integrated controllers (e.g., one or more hand controllers used to interact with virtual objects in augmented reality), and other components. Some HMDs (24) may include processors, memories, software, and other configurations to allow them to operate independently of other devices, while some HMDs (24) may instead be primarily configured to operate displays that receive video output from another connected device (e.g., such as a computer or the environment hub (12)).

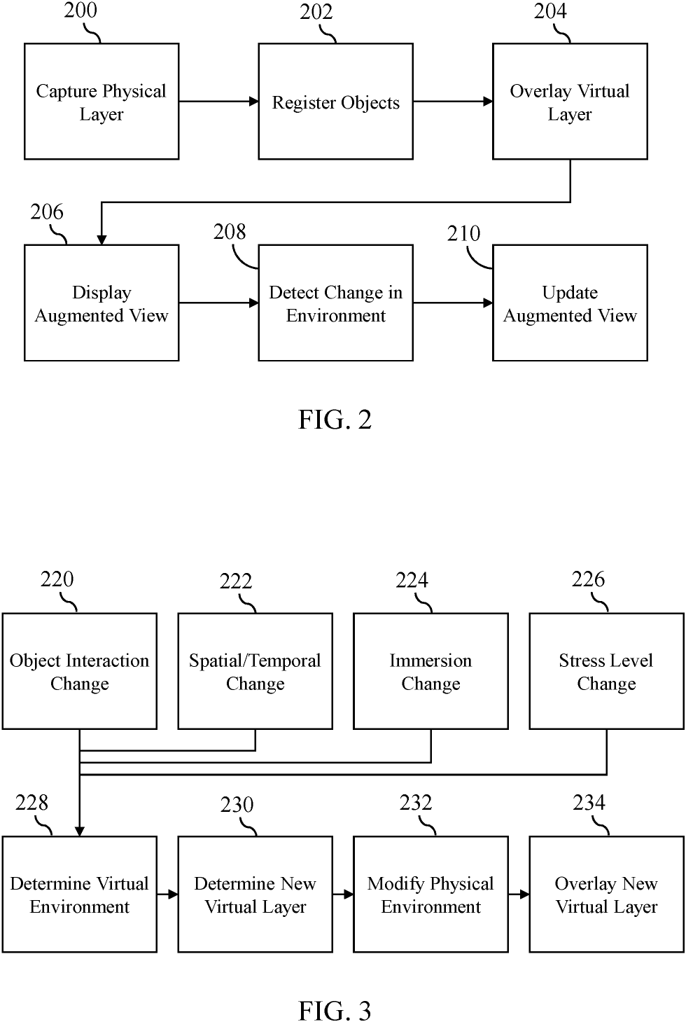

FIGS. 2 and 3 show steps that may be performed to provide a training scenario to a student participating in a training scenario, such as a student wearing the HMD (24). FIG. 2 shows a set of steps that may be performed to provide an update an augmented view via the HMD (24) or another device. The system may capture (200) information about a physical layer of the augmented view using one or more image capture devices or other sensors of the HMD (24) or another device. The captured (200) characteristics of the physical layer may then be used to register (202) one or more objects relevant to the scenario, which may include performing object recognition or other image analysis on the captured (200) characteristics to identify certain objects. This may include identifying the objects based upon their shape or other visual characteristics, identifying objects based upon the placement of fiducial markers or other optical identifiers on their surface, or other types of object identification. This may also include registering the identified objects to a coordinate system or other system that corresponds to a virtual layer of the augmented reality view. Once registered (202), the system is capable of relating the location and orientation of an object in the physical layer with the corresponding positions in the virtual layer.

As an example, this may include identifying a smart mannequin (16) within the field of view of the HMD (24), and then determining the corresponding virtual coordinate space in which that mannequin exists within the virtual layer. This allows the system to overlay (204) renderings from the virtual layer onto the physical layer via a display of the HMD (24) in order to provide an augmented reality view of the simulation area (e.g., either by displaying renderings on a translucent display that allows viewing of the physical layer, or by capturing an image of the physical layer which is modified and redisplayed). Continuing the above example, the overlaid (204) information could include a simple outline or arrow being rendered in the AR view to identify the location and orientation of the smart mannequin (16), or could include more complex graphical renderings to simulate the appearance or physical condition of a virtual patient that corresponds to the mannequin, including the rendering of injuries or other visible characteristics that may be relevant to the scenario, as has been described and referenced above. Once the virtual layer has been determined and combined with the physical layer, the augmented view may be displayed (206) via the HMD and/or other devices used during the training scenario.

The process of capturing, registering, creating, and displaying the augmented view may be performed multiple times per second during the simulation to provide a smooth frame rate and immersive viewing experience during the training scenario, and to account for changes detected (208) in the training environment, which may include movement of the student, movement of the HMD (24), movement of registered objects, or the occurrence of scenario specific events based upon the passage of time, the student’s actions, or other occurrences. As changes occur (208), the augmented view must be updated (210) to reflect the change, which may include rendering and displaying a new virtual layer where the positions and orientations of overlays have changed, or where the overlay has changed due to a scenario driven event (e.g., an improvement in a virtual patient’s condition as a result of treatment, or the passage of time).

FIG. 3 shows a set of steps that may be performed to update the training scenario, including the augmented view and other immersion outputs, as the simulation environment changes (208). Changes can initially occur in the physical layer (e.g., the student themselves moving, turning their head, or moving an object that is part of the simulation) or virtual layer (e.g., a patient’s visual appearance changing in response to a treatment provided during the scenario, or in response to the passage of time during the scenario), and so their impact on the AR view must be determined and then updated to maintain the presentation of the scenario.

Types of changes that may occur include an object interaction change (220), spatial or temporal change (222), immersion change (224), stress level change (226), and other types of changes. An object interaction change (220) may occur as a result of a student using or interacting with a smart tool (14), interacting with a smart mannequin (16), or interacting with another object that is part of the scenario. This could include, for example, using a smart tool (14) or other medical instrument to provide a treatment to a virtual patient such as applying a tourniquet, applying a bandage, injecting a medicine, or providing CPR. Any detected object interaction change may cause changes to the scenario (e.g., changing the state of the virtual patient, influencing the final results of the scenario) or augmented view (e.g., bleeding from a wound overlaid to the augmented view may slow or stop).

Spatial or temporal changes (222) may occur as a result of the passage of time, or the movement of the student or objects that are related to the scenario. Spatial changes may include the student walking around within the AR view, or reorienting their head to see the AR view from different perspectives. In each case, the AR view must be updated to ensure that overlays are positioned and oriented correctly over the physical layer. Temporal changes may include events occurring within the scenario as a result of the passage of time, such as a virtual patient’s condition worsening or improving as a result of treatment, or a virtual structure fire growing in size.

Immersion changes (224) may occur or be triggered by the occurrence of other events or changes within the scenario, and may include operating one or more of the immersion devices (18, 20, 22) to provide additional immersion to the scenario experience. This may include providing audio of a patient coughing or gasping for air in response to receiving a treatment (220) or the passage of time (222) without treatment. Immersion changes (224) may also be triggered by stress level changes (226), such as causing a surface where the scenario is occurring to vibrate to simulate a structural collapse or explosion where a student’s stress level is determined to be low.

Stress level changes (226) may occur in response to measured or determined stress levels for a student participating in the scenario. Stress measurements may be performed with heart rate tracking devices or other bio feedback devices, or stress may be estimated based upon other detectable characteristics of the student (e.g., a microphone within the HMD (24) may measure breathing rate, or eye tracking and/or hand tracking features of the HMD (24) may detected how steady the student’s hands or gaze are).

As has been described, changes that occur may influence the augmented view or immersion of the scenario in different ways, but may also trigger other changes (e.g., a lowering of the students stress level may cause an immersion change (224) or a rapid advancement of the scenario timeline resulting in a temporal change (222)). Generally, the results of changes may include determining (228) the impact of the change on the virtual environment (e.g., applying a bandage to a virtual patient might improve the patient’s condition, dousing a virtual flame might introduce additional smoke), determining (230) a new virtual layer (e.g., an improved patient condition might result in changes to the overlaid appearance of a virtual patient, dousing a fire might reduce the size of the virtual fire), modifying the physical environment (e.g., activating a device to provide audio, olfactory, or other feedback to match the changing virtual environment (228)), and overlaying (234) the new virtual layer to create an updated augmented view (e.g., rendering the virtual patients new appearance).

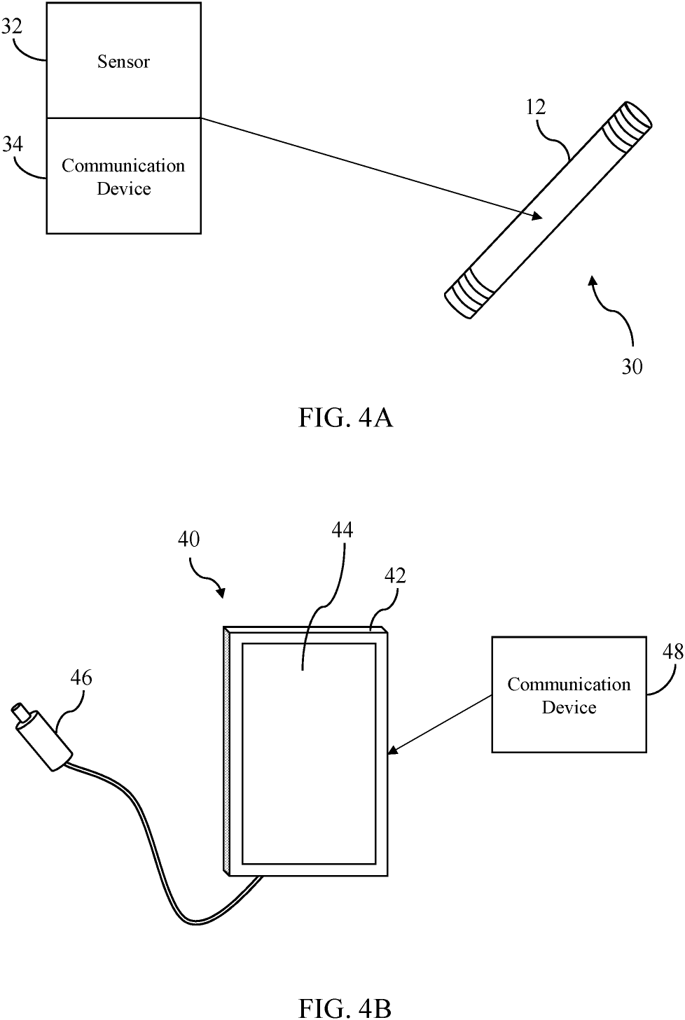

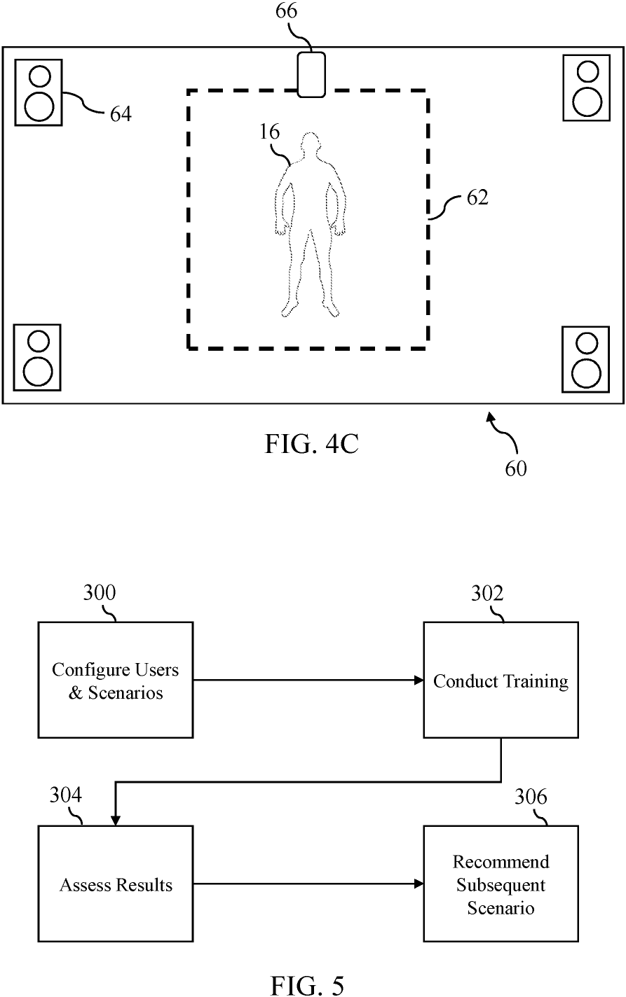

FIG. 4A is a schematic diagram of a tool (30) usable to perform an action during a training scenario, such as described above in the context of the smart tool (14). The shown tool (30) is a tourniquet rod that may be used to turn or tighten a tourniquet during a medical scenario. A body (12) of the tool (30) may contain one or more additional components that allow the tool (30) to be used with the system, such as a sensor (32) and a communication device (34). When the tool (30) is used to tighten a tourniquet, the sensor (32) (e.g., a pressure sensor or other sensor capable of measuring the force applied by the tourniquet wrap to the body (12)) may generate data indicating the tightness of the tourniquet, and may transmit that data to another device, such as the HMD (24), environment hub (12), or server (100), for use with the scenario via the communication device (34). Other similar tools might include, for example, hypodermic needles that report an injection volume, CRP masks that report a volume of passed air, or other devices for which such information is not readily available. Another example of a smart tool is an endotracheal tube (ET) that includes a position sensor configured to interact with a corresponding sensor inside the mannequin in order to determine a relative position of the endotracheal tube. The interaction of the ET tube sensor with the mannequin sensor may generate data usable to determine proper positioning of the ET tube, with a positioning in the trachea indicating a successful treatment task and a positioning in the esophagus indicating an unsuccessful treatment task, with such indications being usable to evaluate results of a scenario or update the state of a scenario (e.g., positioning of an ET tube in the esophagus may cause injury or death).

FIG. 4B is a schematic diagram of a diagnostic tool (40) usable to gather information during a training scenario. The diagnostic tool (40) includes a case (42), a display (44), a probe (46), and a communication device (48). In some implementations, the diagnostic tool (40) may be a tablet device or other computing that is configured to simulate a diagnostic device during a scenario, while in other implementations he diagnostic tool (40) may be a dummy device with minimal information reported via the communication device (48).

For example, one implementation might include a tablet device configured to provide interfaces via the display (44) that are responsive to the scenario and use of the probe (46). In this implementation, when the probe (46) is positioned on a smart mannequin (16) the display (44) may simulate a body temperature reading, heart rate reading, blood oxygenation reading, or other feedback based upon scenario information received via the communication device (48).

In an implementation where the diagnostic tool (40) is a dummy device, the display (44) may be a non-functional surface that includes a visual pattern, fiducial marker, or other markers that allow the tools display to be readily identified during capture and recognition of the physical layer, so that the diagnostic interface may be overlaid onto the diagnostic tool (40) during application of the virtual layer. In this case, the probe (46) may be a simple push button that detects when it is placed against an object and transmits a signal via the communication device (48) to indicate that the device has been activated, which may result in a virtual diagnostic interface being overlaid upon the display (44) surface.

FIG. 4C is a schematic diagram depicting a top down view of a scenario environment (60) usable during a training scenario, which includes several immersion devices as described above. A smart mannequin (16) is positioned within the environment (60), and a haptic device (62) is positioned below where the student will conduct the scenario, which may be operated to provide various levels of haptic feedback during a scenario. A number of speakers (64) are positioned around the environment (60), which may be operated to provide various audible feedback during the scenario. A scent fogger (66) is positioned proximately to where the student will conduct the scenario, which may be operated to introduce immersive smells to the scenario, such as the smell of smoke, or a chemical spill.

As has been described, maintaining an appropriate level of challenge and stress during training may be beneficial for student retention and mastery of skills, especially when translating such skills to real world practice. While the challenge and stress of a scenario may be influenced by the AR experience itself, it may also be advantageously influenced by an SME (102) that is configured to recommend appropriate scenarios to ensure that students are presented appropriately challenging scenarios that are neither trivial, nor so difficult that they are discouraging. As an example of the operation of the SME (102), FIG. 5 shows a set of high level steps that may be performed to provide scenario based training. Such steps may include configuring (300) the system with scenarios and students, conducting (302) training for a student based upon the available configured scenarios and that student’s configurations, assessing (304) the results of the students training scenario, and recommending (306) a subsequent scenario based on the assessed results.

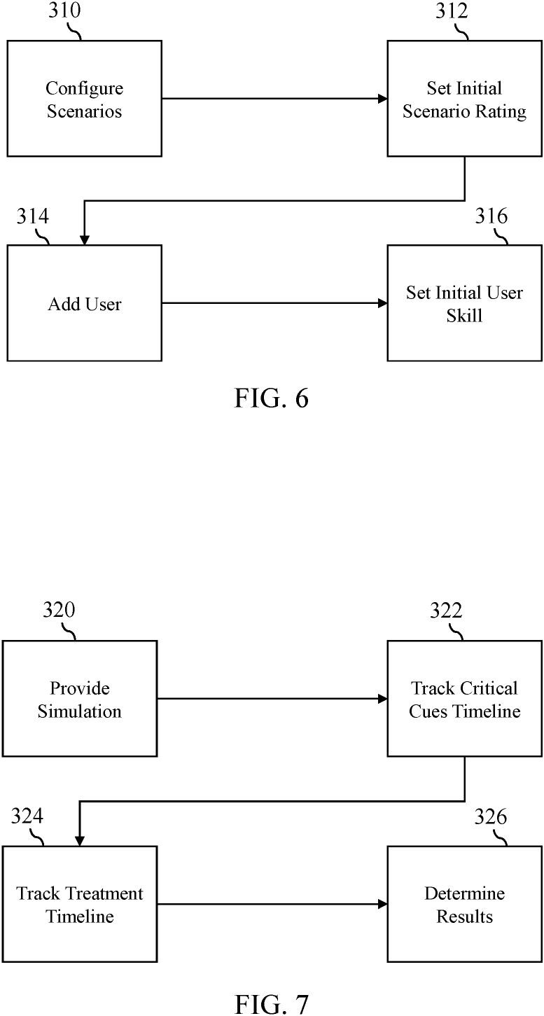

FIG. 6 shows an example of a set of steps that may be performed to configure a system to provide scenario based training. A plurality of scenarios may be configured (310), which may include scenarios that simulate the use of different skills at varying difficulty levels. As an example, where a system provides medical training scenarios based on the ABC emergency medical care method (e.g., Airway, Breathing, Circulation), the plurality of scenarios may include scenarios that are individually focused on Airway, Breathing, and Circulation, as well as combinations thereof. The scenarios may also include multiple scenarios focused on the same skill or skills, but at varying difficult levels, such as scenarios focused on Airway at difficulties ranging from 1 to 10. Scenarios may be manually and statically configured, such that a person creates a particular script for the scenario, or may be dynamically or semi-dynamically generated by the SME (102). This dynamic generation may include, for example, selecting one of several basic scenario aspects, such as Airway skills, and then increasing or decreasing the difficult of the scenario by adding another skill, such as Breathing, or by introducing additional elements to the scenario that increase the difficulty, such as virtual smoke, poor lighting, or other stress inducing factors as described above.

Each scenario that is configured (310) may also be associated with an initial rating that is representative of its difficulty. In some implementations, the rating may be dynamically determined based upon the scenario results of students, instructors, or others that are participating in the scenarios. In some implementations of the system, scenario difficulty may be based at least in part upon a determined degree of surprise or complexity inherent in the scenario, which may be determined and/or expressed in the context of a Shannon entropy rating for the scenario. Shannon entropy is a measurement of uncertainty associated with a system or variables. In some implementations, the SME (102) may be configured to dynamically calculate Shannon entropy ratings for a plurality of scenarios, across the entire system or in relation to individual skills, based upon the results of scenarios for a plurality of students or other users participating in the scenarios, as will be described in more detail below. The Shannon entropy equation may be expressed as:

$$H \left(X\right) = - {\sum }_{i = 0}^{N - 1} {p}_{i} {log}_{2} {p}_{i}$$

Students may be added (314) as users of the system, which may include granting them unique credentials for accessing the system, and creating a user primary key or other identifiers which all other records for the user may be associated with. While the SME (102) will track and determine a student’s skill level and growth over time, it may be beneficial for a student’s initial skill level to be set (316), which may include participating in a scenario that is configured to provide results indicative of placement, or may instead include providing details of past experiences with the trained skills (e.g., years of professional or academic experience with the skill, certifications related to the skill).

FIG. 7 is a flowchart showing a set of steps that may be performed to conduct training during scenario based training provided by the SME (102). Such steps may be performed as part of, or in parallel with, steps such as those shown in FIGS. 2 and 3, and previously described above. While providing the scenario simulation (320), as has been described, the system may track (322) and generate a timeline of critical cues that are noticed by the student. A critical cue may include an aspect of the simulation that the student takes note of during the scenario simulation, which may be determined by gaze tracking, hand tracking, or otherwise tracking the student’s behavior and activities while they are gathering information on the scenario. As an example, information from the HMD (24) may be used to identify locations of a virtual patient that the student is looking at, which may relate to critical cues such as the patients lividity, respiration rate, visible wounds, or other conditions. Critical cues may also relate to the use of diagnostic tools or methods to gather information about the scenario, such as checking a virtual patient’s pulse, blood oxygenation, or other characteristics. A tracked (322) timeline of critical cues will indicate the order and the time at which the student gained key pieces of information throughout the scenario, which may be useful for assessing the student’s performance in the scenario, as well as for determining the challenge or complexity of the scenario.

The system may also track (324) and generate a treatment timeline for each action taken by the student towards resolving the scenario. Tracked treatments may include actual treatments as well as diagnostic actions, and may include, for example, applying bandages, performing CPR, applying a tourniquet, injecting a medicine, or other actions. The performance of treatment actions may be determined based upon object tracking and identification via the HMD (24), or based upon feedback from smart devices in use during the scenarios such as smart tools (14) or smart mannequins, or a combination of the above. In addition to allowing the scenario and AR view to update in response to treatment actions, tracking (324) the timeline of treatments will also indicate the order and time at which the student performed certain treatments, which may be useful for accessing the student’s performance in the scenario, as well as for determining the challenge or complexity of the scenario.

The system may also determine (326) the results or outcome of the scenario when the scenario is completed by the student, either by successfully spotting critical cues and providing treatments, or due to the passage of time. The determined (326) results may be expressed as tracked timelines of critical cues, or treatments, or both, or may be expressed as one or more outcomes determined by those timelines. For example, when faced with a virtual patient that has sustained a life threatening injury, a treatment timeline that shows appropriate treatments being rapidly applied is indicative of a successful result.

The SME (102) may guide students through the learning process based upon their determined (326) results and the determined difficulty, challenge, or complexity ratings of scenarios available to the system. While treatment timelines and other results of the simulated scenario may indicate a simple success or failure in the scenario (e.g., patient survived, patient died), such a binary system may not be beneficial in terms of student retention and mastery. Rather, the SME (102) may be configured to perform one or more assessments of the scenario results to determine relative performance of the student, in order to provide a recommendation of one or more subsequent scenarios appropriate for their stage of skill development.

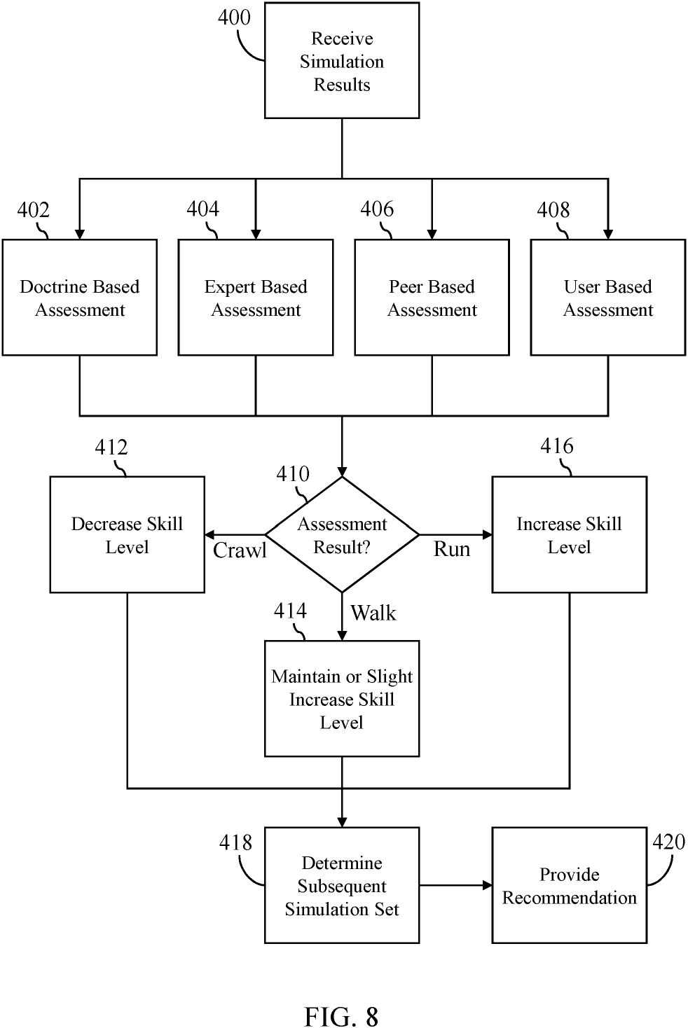

As an example, FIG. 8 shows a set of steps that may be performed to assess and provide recommendations based on conducted training. As the results of simulated scenarios are received (400), the system may perform one or more assessments to determine whether, and to what extent, the student has mastered the associated skills. As an example of assessments that may be performed, the system may perform a doctrine based assessment (402), which compares the student’s results to an ideal doctrinal approach to the scenario, expert based assessment (404), which compares the student’s results to that of one or more experts, peer based assessment (406), which compares the student’s results to that of their peers who are also using the system, and user based assessment (408), which compares the student’s results to that student’s own prior results.

After determining the assessment results, the system may then modify that student’s level of skill master for one or more skills based on those results (410). Refactoring the student’s skill level may be accomplished in varying ways, but as one example the system may determine, based upon the assessment results, that the student is either “crawling” (e.g., struggling, much room for improvement, perhaps overwhelmed), “walking” (e.g., showing steady improvement), or “running” (e.g., at or near mastery) with respect to one or more skills. Based on this determination, the system may then decrease (412) that student’s skill level, maintain or increase (414) that student’s skill level, or increase (416) that student’s skill level. The student’s skill level may be expressed by the system as a score, rating, level, or tier that relates to the plurality of scenarios, or may be expressed by a designation of a scenario challenge rating that they are currently mastering, or have previously mastered, or in other ways. Table 1 below shows an example of scenarios ranked by difficulty or complexity, and categorized as appropriate for a student that is crawling, walking, or running with respect to a certain skill (e.g., Airway Scenario 9 is appropriate for a student who has been assessed as at or near “running” level of skill mastery for airway emergency medical treatment scenarios).

TABLE 1

Example of scenario ranking system

| | Massive Hemorrhage Scenarios | Airway Scenarios | Respiration Scenarios | Circulation Scenarios | Hypothermia Scenarios |
|---|---|---|---|---|---|
| 9 | Run | Run | Run | Run | Run |
| 8 | Run | Run | Run | Run | Run |
| 7 | Run | Walk | Run | Run | Walk |
| 6 | Walk | Walk | Run | Walk | Walk |
| 5 | Walk | Walk | Walk | Walk | Walk |
| 4 | Walk | Crawl | Walk | Walk | Crawl |
| 3 | Crawl | Crawl | Crawl | Walk | Crawl |
| 2 | Crawl | Crawl | Crawl | Crawl | Crawl |
| 1 | Crawl | Crawl | Crawl | Crawl | Crawl |

After the student’s skill level has been modified and/or determined, the system may then determine (418) a set of subsequent scenarios that are appropriate for that skill level, which may use fuzzy logic to identify scenarios that are within a configured range of that users skill level, whether more challenging or less challenging, and may also identify scenarios that are focused on different or related skills (e.g., where a prior completed scenario focuses on Airway aspects of the ABC method with Breathing as a secondary aspect, a subsequent scenario may instead focus primarily on Breathing). The system may then provide (420) the recommended scenario set to the student via the HMD (24), student device (104), instructor device (106), or another interface so that the student or instructor may select a subsequent scenario immediately after completing a prior scenario, providing a seamless and efficient training experience.

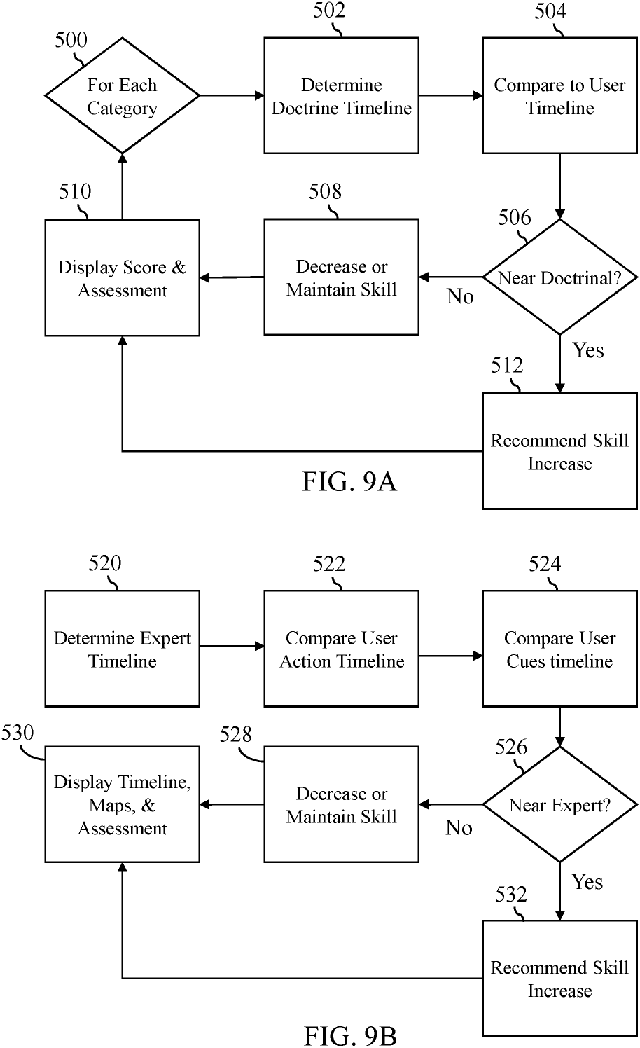

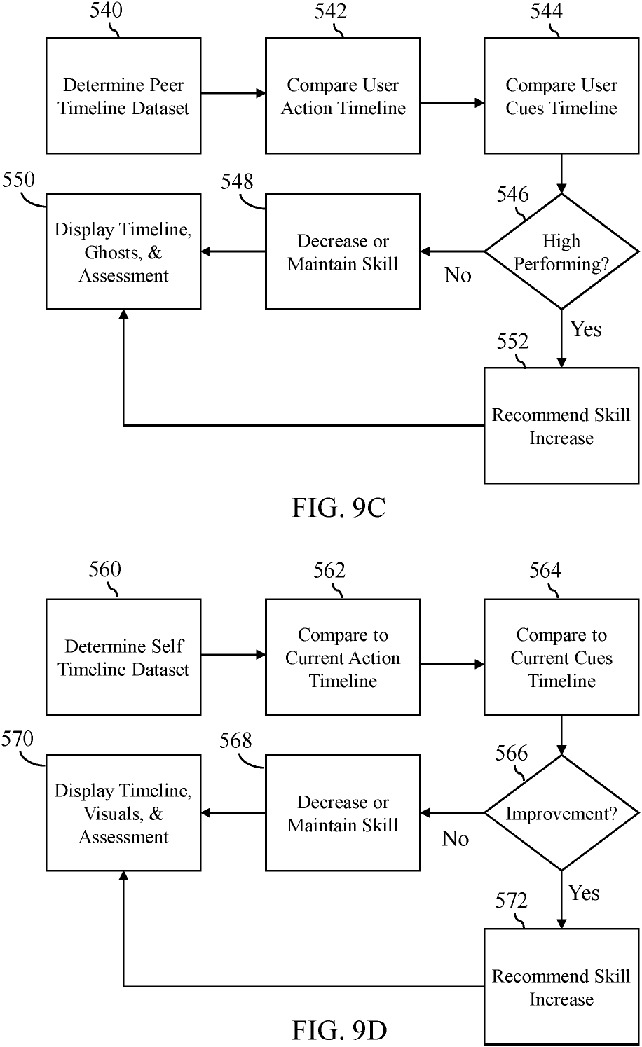

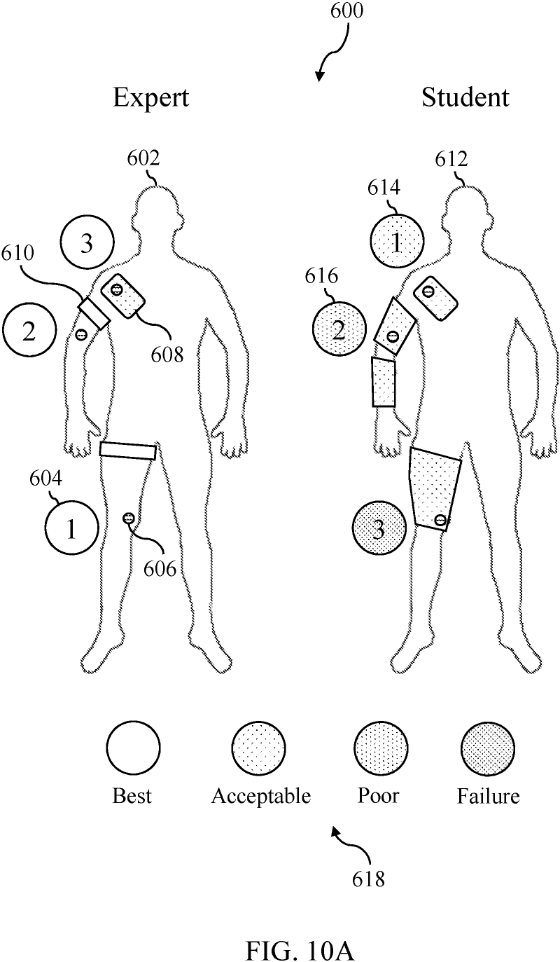

FIG. 9A shows a set of steps that may be performed to assess scenario results using a doctrinal approach. When assessing scenario results using a doctrinal approach, each of several different categories within the doctrine may be separately examined (500). As an example, with reference to the Advanced Trauma Life Saving (ATLS) method, different doctrinal categories may include Triage Considerations, Airway Assessment, Breathing and Ventilation, Circulation and Hemorrhage Control. For each category (500), the system may determine (502) the makeup of a doctrine timeline, which may be stored in a database, or may be determined by applying a configured set of doctrine rules to the characteristics of a particular scenario. The determined (502) doctrine timeline may then be compared (504) to a particular user or student timeline, which may include comparing the order and times in which certain critical cues are checked for, certain diagnostic steps are taken, and certain treatment steps are performed. Where the comparison (504) indicates that the student timeline was substantially similar to a doctrinal timeline (506) (e.g., events on the student timeline are within a configured number of spots of their ideal order, are performed within a configured time threshold of their ideal time, or both), the system may recommend (512) that a user’s skill level increase for subsequent scenarios so that they are appropriate for a heightened skill. Where the user timeline is not substantially similar (e.g., within a configured threshold of), the system may recommend (508) that the user skill level be decreased or maintained at current levels. After providing a recommendation (508, 512), the system may display (510) results of the scenario, the assessment, or both to the student via the HMD (24) or another device. The displayed (510) results may include scenario information in various forms, such as text, numeric data, graphs, charts, or other visualizations, audio or video presentations, or graphical interfaces that display aspects of the augmented view, or rendered versions of objects related to the scenario, as will be described in more detail below.

FIG. 9B shows a set of steps that may be performed to assess scenario results using an expert approach. The system may determine (520) an expert timeline for the scenario, which may be configured and stored by the system based upon one or more expert evaluations of the scenario. Actions occurring in the expert timeline may then be compared (522) to actions that occurred in the user timeline, and cues occurring in the expert timeline may also be compared (524) to cues that occurred in the user timeline. Where the comparison indicates that the student’s timeline is substantially similar to the expert timeline (526) (e.g., within a configured order, time, or both, for actions and cues), the system may recommend (532) a skill increase for that user, otherwise, the system may recommend (528) that the student’s skill level be decreased or maintained. The system may then display (530) results of the scenario as has been described, which may include information in various forms including visual depictions of the timeline comparison, visual maps of users actions and cues, and other information.

FIG. 9C shows a set of steps that may be performed to assess scenario results using a peer based approach. The system may determine (540) an average peer timeline for the scenario, which may be configured and stored by the system based upon one or more evaluations of the scenario by other student users of the system (e.g., either scenario results that had a successful outcome, or scenario results that occurred immediately before the student proceeding to a next skill level or otherwise indicating mastery of the skill). Actions occurring in the peer timeline may then be compared (542) to actions that occurred in the user timeline, and cues occurring in the peer timeline may also be compared (544) to cues that occurred in the user timeline. Where the comparison indicates that the student’s timeline is substantially similar to the peer timeline (546) (e.g., within a configured order, time, or both, for actions and cues), the system may recommend (552) a skill increase for that user, otherwise, the system may recommend (548) that the student’s skill level be decreased or maintained. The system may then display (550) results of the scenario as has been described, which may include information in various forms including visual depictions of timelines, visual depictions of objects from the augmented view, and other information.

FIG. 9D shows a set of steps that may be performed to assess scenario results using that student’s own past results. The system may determine (560) a past timeline for that student’s performance in that scenario, or in scenarios testing the same skills, which may be configured and stored by the system based upon the student’s previous participation in scenarios. Actions occurring in the past timeline may then be compared (562) to actions that occurred in the user’s current scenario timeline, and cues occurring in the past timeline may also be compared (564) to cues that occurred in the user’s current scenario timeline. Where the comparison indicates that the student’s timeline is substantially similar to the past timeline (566) (e.g., within a configured order, time, or both, for actions and cues), the system may recommend (572) a skill increase for that user, otherwise, the system may recommend (568) that the student’s skill level be decreased or maintained. The system may then display (570) results of the scenario and assessment, which may include information in various forms as has been previously described.

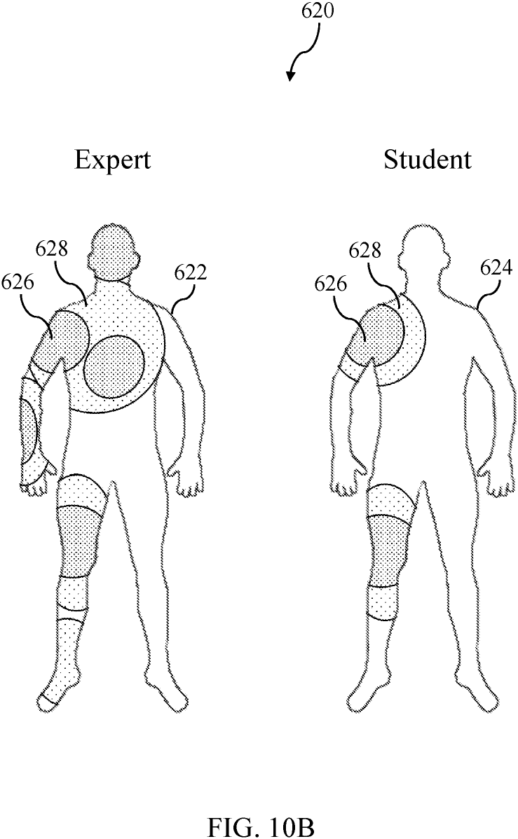

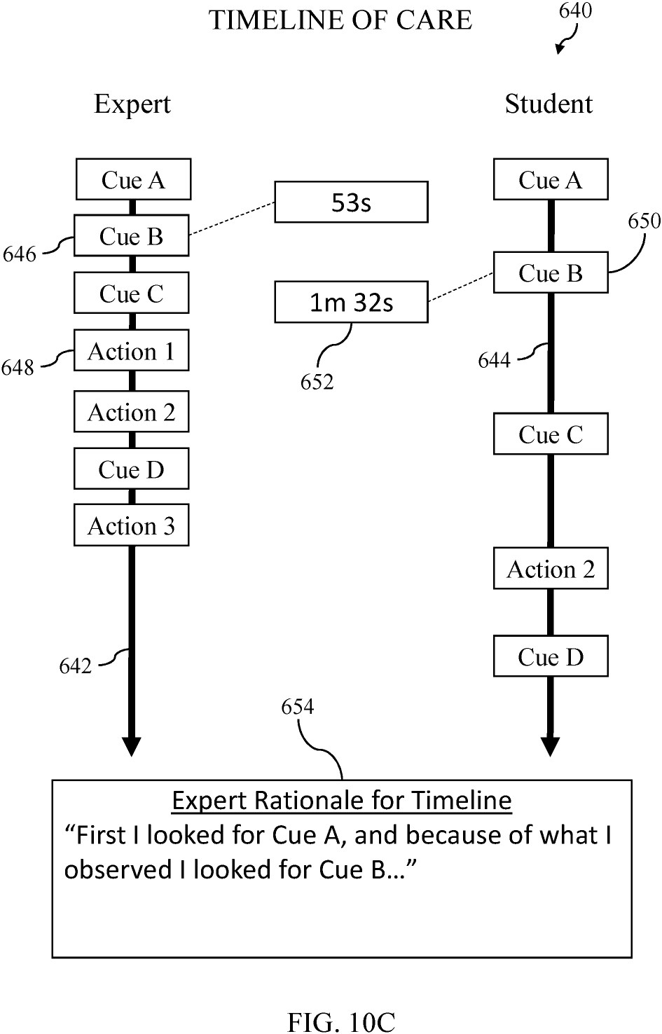

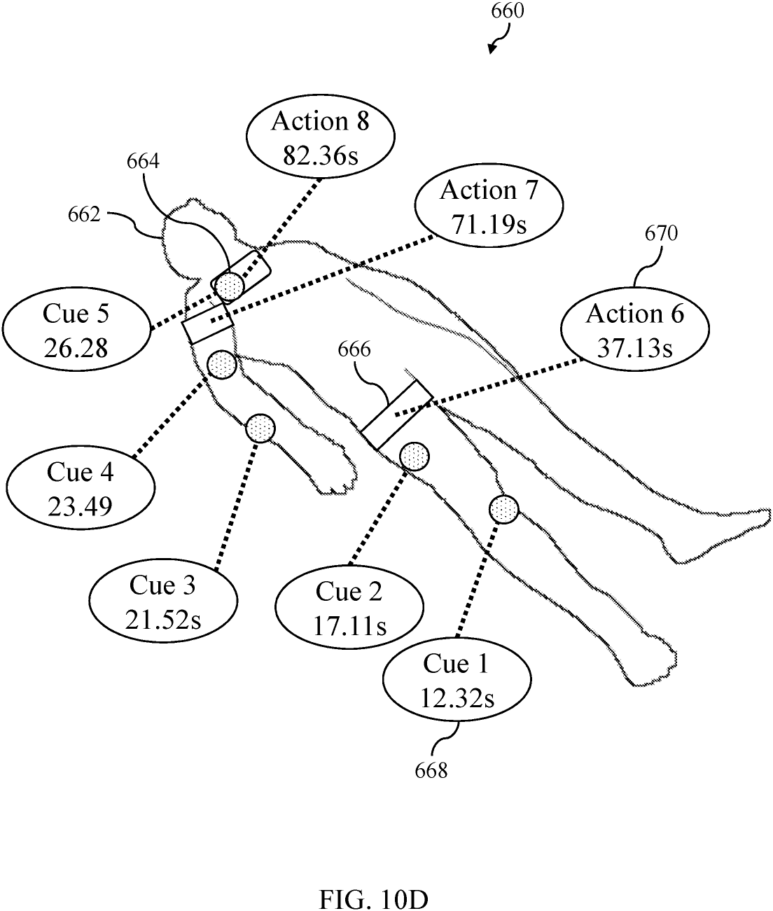

FIGS. 10A through 10D each show interfaces that may be displayed to a user of the system, such as students or instructors, via device such as the HMD (24), student device (104), or instructor device (106). FIG. 10A shows a scenario result interface (600) that may be displayed to a student or instructor after assessment of a scenario, and may be configured to provide a comparison of a student timeline to an expert or other comparison timeline. The interface (600) includes a visual depiction of mannequins (602, 612) for the student and expert, which may be simple outlines or graphics, or may substantially match the mannequin as depicted in the AR view provided during the scenario simulation. A set of treatment indicators (604) may be positioned near spots of the mannequin that received a treatment action during the scenario. The set of treatment indicators (604) may be presented as various shapes or markers, and may include numbers to indicate the order they were performed in, or colors, patterns, or other visual distinctions to indicate whether that action was an acceptable or unacceptable action to be performed during that scenario, or in that particular order. A set of condition indicators (606) is also shown, which may indicate wounds or other medical conditions and their location on the mannequins (602, 612). Treatments may also be depicted in the interface (600), such as bandages (608), tourniquets (610), or other provided treatments.

With reference to the student mannequin (612), the interface (600) shows that, for this exemplary scenario, the student performed treatment actions that were in different orders than the expert, and that were different types of treatments. A visual key (618) is included to aid in interpreting the interface (600). As can be seen, the student performed treatment a chest bandage treatment (614) first, while the expert performed the same treatment third. Additionally, instead of performing tourniquet treatments, the student performed bandage treatments on the legs and arms (616), subsequent to the chest bandage treatment. Based on the prior assessment, the interface (600) indicates to the student that their timeline actions varied from “acceptable” to “failure.”

FIG. 10B illustrates another scenario result interface (620) for comparing a student gaze dataset a gaze dataset from a comparison scenario result (e.g., experts, peers, self). The interface (620) depicts mannequins for each of the student mannequin (624) and comparison mannequin (622). Each mannequin is overlaid with colors, patterns, markers, or other visual distinctions that indicate the location and extent of the student’s or comparison’s gaze during the scenario, based upon gaze tracking data that is captured by the HMD (24) or another device during the scenario. For example, the expert mannequin (622) indicates that the expert focused on the virtual patient’s head, mid-chest, and lower arm, in addition to areas where visible wounds were present near the upper chest, upper arm, and upper leg, as shown by heavily patterned areas (626), and also occasionally checked the virtual patient’s lower leg and surrounding areas as shown by the lightly patterned areas (628). In comparison, the student mannequin (624) indicates that the student’s gaze focused primarily on the areas where wounds were visible, visually indicating that in the future the student should avoid fixating on visible wounds.

FIG. 10C illustrates another interface (640) for comparing a student timeline to an expert timeline. Directional timelines for a student (644) and expert (642), or other comparison, are depicted with blocks or other indicators that represent the occurrence of an action, or observation of a critical cue. For example, the expert timeline (642) includes a number of cues (646) and actions (648), showing the order in which the expert approached the scenario, and the time in which certain cues or actions were registered. The student timeline (644) shows the same, with corresponding scale, so that the student may visually determine that the student observed Cue B (650) (e.g., labored breathing) somewhat slower than the expert observed Cue B (646). The interface (640) may include, either statically or based upon a hover over, pop up window, or other user selection or action, a detailed comparison (652) that shows the exact time in the timeline in which two equivalent events occurred, such as the expert noting Cue B at 53 seconds, and the student noting Cue B at 1 minute 32 seconds. The interface (640) also includes an explanation section (654) that explains why the expert noted the cues and performed the actions in the shown order. The explanation section (654) may present several sentences or paragraphs of information, or may present a subset of that information based upon the student clicking on a certain cue or action box along the timeline. As an example, upon clicking on Action 1 (648) on the expert timeline (642), the explanation section (654) may show a subset of the expert rationale that describes only why the expert decided that action.

FIG. 10D illustrates yet another interface (660) for providing results of a scenario. The interface (660) may show data based on a student’s scenario result, or an expert, peer, or other scenario result, and may show a single mannequin (662) as depicted in FIG. 10D, or may show multiple mannequins for comparison (e.g., such as in FIG. 10A). The interface (660) provides indicators (664) where wounds or other virtual patient conditions that are associated with cues or treatments are present on the mannequin (662). The mannequin (662) also includes visual representations of provided treatments, such as a tourniquet (666) applied to the upper leg, or bandages or other treatments applied elsewhere. A series of indicators (668) may be visually linked to other indicators (664) or treatment areas (666) which provide information such as the order in which the indicator (668) occurred, the time at which the indicator occurred, and the type of indicator (e.g., cue, diagnosis, treatment).

For example, as shown the interface (660) visually indicates to the student that the first event occurring in their scenario was observation of a Cue at around 12 seconds, and the sixth event occurring in their scenario was performing a treatment action (670) at around 37 seconds. The interface (660) may also present comparison values, such that the student might determine that while they performed the treatment action (670) at 37 seconds, other students or experts performed the treatment action (670) at 32 seconds, or performed the treatment action 8 seconds after the prior event (e.g., Cue 5), while the student performed the treatment action 11 seconds after the prior event. Such comparison may be provided by a second mannequin (662), may be included in the event indicators (668, 670), or may appear as hover over or pop information based upon user interactions with the interface (660).

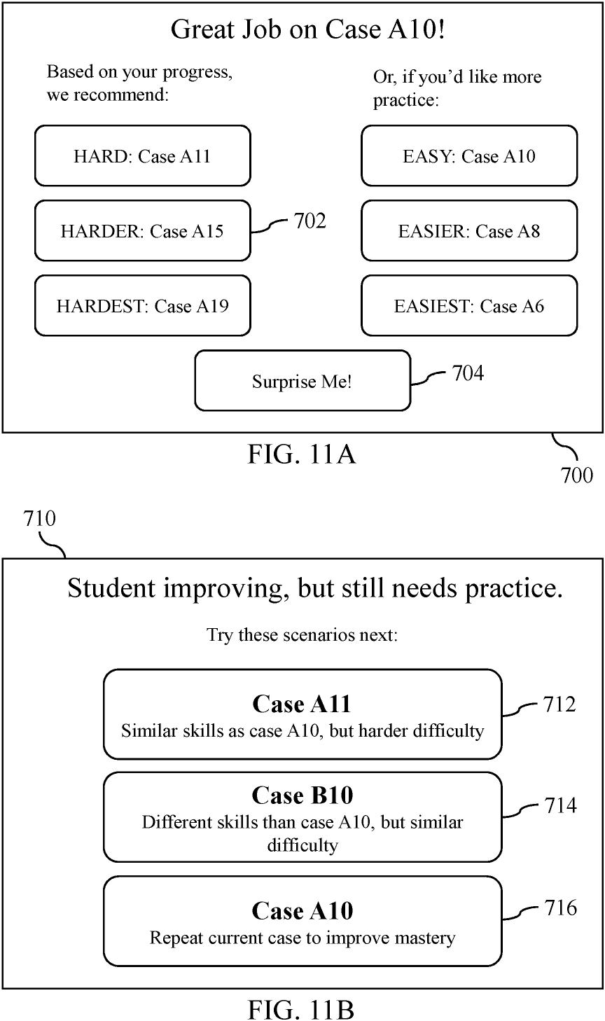

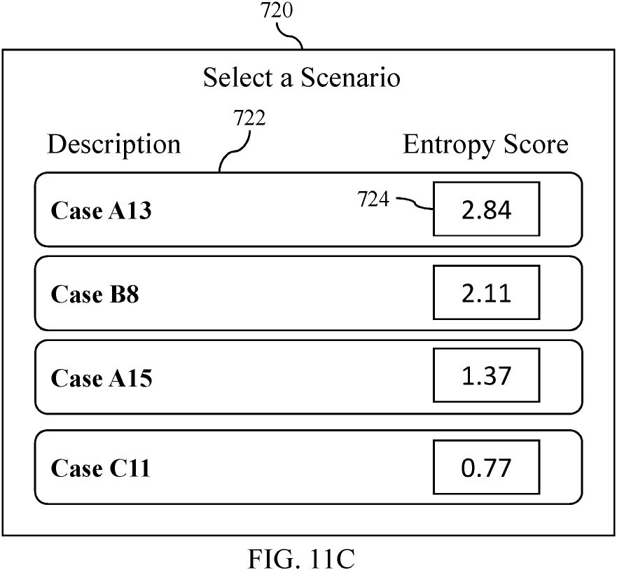

FIGS. 11A through 11C each illustrates interfaces that may be presented to a student or instructor upon completion of a scenario in order to provide (420) a recommendation for subsequent scenarios. An interface (700) shown in FIG. 11A presents selectable interface elements (702) for cases or scenarios having various degrees of challenge relative to the most recently completed scenario (e.g., hard, harder, hardest, easy, easier, easiest). The recommended scenarios are each provided (420) based upon the assessment of that student’s prior results, as well as the difficulty ratings determined (312) for scenarios available to the system, as has been previously described. Presented scenarios may include those that represent between a small but still beneficial increases in challenge, to the largest increase in challenge that is still likely to provide beneficial training opportunities, with the same being true for the scenarios of lower skill levels (e.g., each of the “easy” and “easiest” cases is still likely to provide some benefit). The interface (700) also includes a semi-random scenario button (704) that will provide a subsequent scenario that is randomly selected from all scenarios that are likely to be beneficial (e.g., the random scenario could be the “hard” scenario, “hardest” scenario, or “easiest” scenario). This may be beneficial to provide the student a scenario without expectation of the difficulty level, to determine whether they will oversimplify difficult scenarios, or imagine unnecessary complexity for simple scenarios.

FIG. 11B illustrates an instructor interface (710) that may be presented to an instructor when a student completes a scenario, and may allow the instructor to select the next scenario without student input or knowledge of the selection. A first button (712) may be selected to provide a scenario testing similar skills, but at a higher difficulty. A second button (714) may be selected to provide a scenario testing different skills at the same or similar difficulty. A third button (716) may be selected to provide a scenario that is identical to the prior scenario, or that tests the same or similar skills, at the same or similar difficulty level. As with prior examples, the selections presented via the instructor interface (710) may be provided (420) based upon assessment of the student’s results, and configured challenge levels for available scenarios, as has been described.

FIG. 11C illustrates an interface (720) for selecting scenarios based upon a complexity score, or Shannon entropy score, as has been described. Buttons (722) may be presented for a set of scenarios which may include descriptions of the scenario and skills tested, and that also includes an entropy score (724) for each recommendation. The interface (720) allows a student or instructor to sort and search scenarios based upon a determined indication of their surprise or complexity, rather than based upon their description or other relative order.

The Shannon entropy score may be particularly useful as a metric for ranking the complexity, unpredictability, or challenge for different scenarios. This is because the Shannon entropy score can provide a concrete indication of the various ways in which other users have approached the scenario, with a lower score indicating fewer information processing elements, or more obvious elements, for completing the scenario, and a higher score indicating more information processing elements, or less obvious elements, for understanding and responding to a scenario.

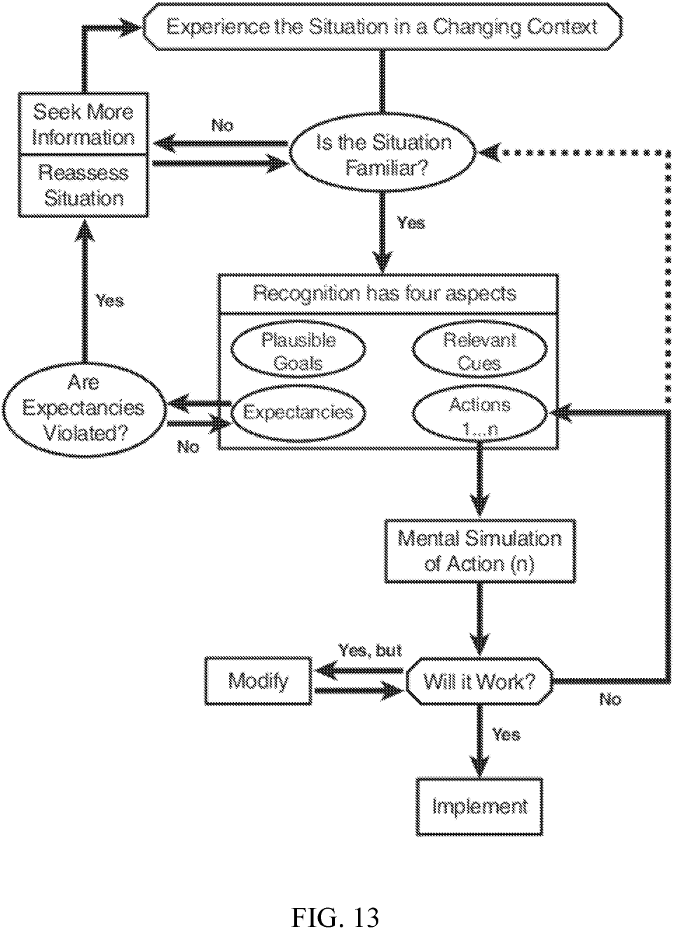

The Shannon entropy score is also advantageous for application to training in real-world domains where satisficing decision-making strategies are preferred over optimizing decision-making strategies. The information processing strategies in such domains are often described with naturalistic models that focus on situation assessment and rapid recognition skills versus Bayesian approaches or other prescriptive models that presume a higher degree of information certainty, fixed goals and a priori assumptions about potential decision outcomes. The Recognition Primed Decision (RPD) model is an example of a relevant descriptive model for such domains and is illustrated in FIG. 13. The RPD model describes an information processing approach that has been found to be highly descriptive of decision-making approaches employed in dynamic real-world environments. Typically these environments include circumstances where significant time pressure exists and the cost of delayed action are substantial. The decision-making approach of firefighters, first responders, doctors, and other professionals has been shown follow the RPD model as a means to evaluate and apply their skills to a scenario that presents complex information and problems. As a general summary, with reference to FIG. 13, the RPD model describes that a decision maker attempts to recognize a scenario based on goals, expectancies, relevant cues, and possible actions. Based on recognition or non-recognition of the scenario, the actor may either reassess or gather more information on the scenario, or may mentally simulate the results of one or more possible actions and choose the action that is most likely, with or without some modification, to resolve the scenario if implemented.

The training system of FIG. 1 provides, executes, and evaluates training scenarios based upon an RPD model that measures or captures relevant user reactions such as critical cue recognition, diagnostic steps and related expectancies, and actions taken to treat or otherwise address the problem presented in the scenario. When combined with Shannon entropy scoring, the resulting evaluation system provides meaningful, non-arbitrary, quantitative measurements of scenario difficulty that may be applied as described herein. This is because the Shannon entropy scoring approach provides a result that quantifies the value of information in a way that is agnostic to the class or type of information. When combined with information relevant to the RPD model quantified by the training system (e.g., cues, goals, expectancies, actions) the result is a quantitative measurement related to the effectiveness of human decision making that has real meaning, driven by the underlying data, rather than being an arbitrary scoring system.

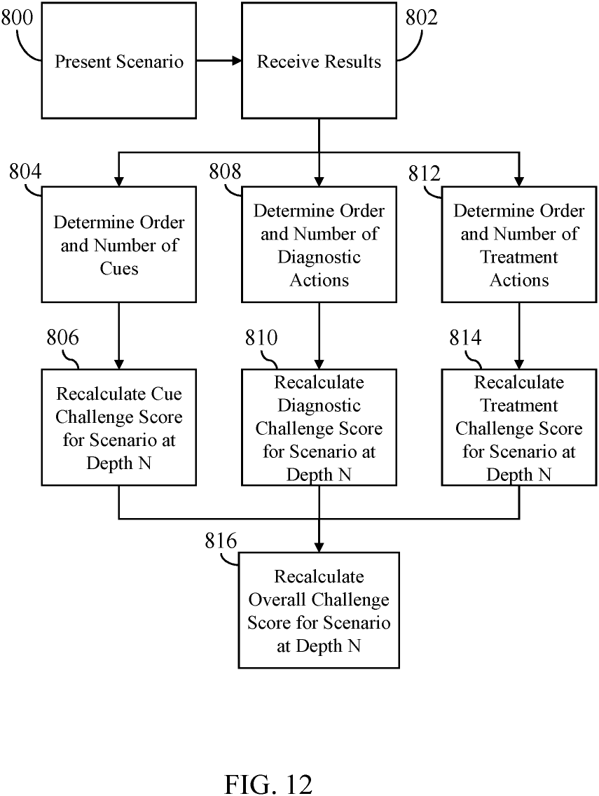

As an example of how the SME (102) or another process might determine and manage the Shannon entropy scores for a plurality of scenarios, FIG. 12 shows a set of steps that may be performed to determine a complexity metric for a plurality of scenarios configured for the system. Initially, each scenario may be set (312) with an equal rating (e.g., a value of 1), and as scenarios are completed by experts, students, or others the ratings may be adjusted based on the timelines and results (e.g., the rating for a completed scenario may increase, and the rating for another scenario may decrease). In this manner, the students that are using the system may determine and adjust the complexity metric for each scenario over time. In some implementations, scenarios may be set (312) with unequal ratings which adjust over time, or may be set (312) with equal ratings that are adjusted by a set of expert test users participating in the scenario a number of times prior to its availability to students.

As each scenario is presented (800) and results are received (802), the system may analyze the types of events occurring during the scenario, and the order of events occurring during the scenario. In varying implementations, the system may analyze timelines of cues (e.g., the student notices the virtual patient looks pale), timelines of diagnostic actions (e.g., the student uses a pulse oximeter on the virtual patient), timelines of treatment actions (e.g., the student provides oxygen to the virtual patient), or other timelines, or combinations of the above. In some implementations, the system may analyze the overall timeline more generally, without regard to the type of event. Generally, the analysis will include determining the total number of possible events that might occur at certain points along the timeline, and then determining which of the possible events actually did occur at certain points along the timeline.

As an example, one augmented reality scenario might provide smart tools (14) or other instruments that allow for five possible treatments to be provided to a virtual patient, and successful completion of the scenario might involve using three of those possible treatments. To determine the complexity metric, the system may gather scenario timelines and results for a plurality of instances of the scenario and determine, to a configured depth of the timeline, which treatment action was performed first, second, third, and so on. Table 2 below provides an exemplary dataset of inputs and results for a complexity calculation, such as the Shannon entropy metric, for four different scenarios, with five different treatment options, based on the percentage of scenario participants that selected each treatment option as their first treatment during the scenario (e.g., 75% of students testing Scenario A chose Treatment 1 as their first action). As can be seen from Table 2, the entropy score increases as the scenario results reflect a wider variability of first treatment actions chosen by participants. While Table 2 reflects entropy scoring based upon a timeline depth of N=1 (e.g., probability of first action), scoring could be based upon varying depths such as N=2 (e.g., first two actions), N=3, and so on.

TABLE 2

Exemplary complexity calculation input and results

| | Treat 1 | Treat 2 | Treat 3 | Treat 4 | Treat 5 | Entropy Score |
|---|---|---|---|---|---|---|
| Scenario A | 75% | 15% | 0% | 0% | 10% | 1.05 |
| Scenario B | 75% | 10% | 5% | 5% | 5% | 1.29 |
| Scenario C | 52% | 11% | 11% | 11% | 15% | 1.95 |
| Scenario D | 21% | 20% | 18% | 19% | 22% | 2.32 |

Returning to FIG. 12, as results are received (802) for a particular scenario, the system may determine (804) the order of actual cues, and number of possible cues involved in the scenario, and may recalculate (806) the entropy score for the scenario to a configured depth of N in order to update the entropy metric to reflect the new scenario results. Additionally or alternatively, the system may determine (808) the order of actual diagnostic actions, and number of possible diagnostic actions involved in the scenario, and may recalculate (810) the entropy score for the scenario to a configured depth of N to reflect the complexity of diagnostic actions. Additionally or alternatively, the system may determine (812) the order of actual treatment actions, and number of possible treatment actions involved in the scenario, and may recalculate (814) the entropy score for the scenario to a configured depth of N to reflect the complexity of treatment actions. Additionally or alternatively, the system may (816) recalculate an overall challenge score for the scenario to a configured depth of N to reflect a combined, aggregate, or average challenge score previously determined (806, 810, 814), or may recalculate an overall challenge scored based upon actions taken, regardless of type (e.g., cues, diagnostics, treatments, assessments, goals, expectancies), to a configured depth of N to reflect general complexity of the scenario, or similar approaches.

In some implementations, the system may maintain separate entropy scores for each scenario that reflect the complexity of different aspects of the scenario. For example, with reference to FIG. 12, the system may allow students or instructors to search for and select a scenario based upon having a very challenging set of cues (806), a very challenging set of diagnostic actions (810), or a very challenging set of treatment actions, instead of or in addition to searching for scenarios based upon an aggregate or general challenge rating.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. An augmented reality training system providing immersive training scenarios to a user, comprising:
(a) a wearable augmented reality viewing device;
(b) a computing device comprising a display screen, the computing device being in communication with the wearable augmented reality viewing device;
(c) a physical object, the physical object being in communication with the computing device; and
(d) one or more markers positioned on a surface of the physical object; wherein the wearable augmented reality viewing device comprises in memory executable instructions for:
(i) capturing information of a physical image;
(ii) creating the training scenarios, wherein the training scenarios include an initial difficulty rating;
(iii) displaying the physical image on the wearable augmented reality viewing device and on the display screen of the computing device, the physical image presenting one or more virtual critical cues;
(iv) assessing the user’s results during the training scenarios by comparing the user’s results to an ideal doctrinal or expert-based approach to the training scenarios; and
(v) modifying the training scenarios based on the user’s results of the training scenarios.

2. The system of claim 1, wherein the system further comprises determining a set of subsequent scenarios that correspond to the user’s results, wherein the subsequent scenarios may be more challenging or less challenging than the training scenarios.

3. The system of claim 1, wherein the system further comprises an instructor interface that is presented to an instructor when the user completes the training scenarios, wherein the instructor interface permits the instructor to select additional training scenarios without the user’s input or knowledge.

4. The system of claim 3, wherein the ideal doctrinal approach may include Advanced Trauma Life Saving (ATLS) methods, wherein the ATLS methods may include Triage Considerations, Airway Assessment, Breathing and Ventilation, Circulation and Hemorrhage Control.

5. The system of claim 1, wherein the ideal doctrine approach determines a doctrine timeline from a set of doctrine rules, wherein the doctrine timeline is compared to the user’s results to check for the critical cues and accurate step performances, wherein the training scenarios’ complexity is increased if the doctrine timeline is within a configured threshold of similarity to the user’s results, wherein the training scenario’s complexity is decreased or maintained at a current level if the doctrine timeline is not within the configured threshold of similarity to the user’s results.

6. The system of claim 1, wherein the expert-based approach determines an expert timeline for the training scenarios, wherein the expert timeline is based upon one or more expert evaluations of the training scenarios, wherein the expert timeline is compared to the user’s results to check for the critical cues and accurate step performances, wherein the training scenarios’ complexity is increased if the expert timeline is within a configured threshold of similarity to the user’s results, wherein the training scenario’s complexity is decreased or maintained at a current level if the expert timeline is not within the configured threshold of similarity to the user’s results.

7. The system of claim 1, wherein a Shannon entropy score is determined from Shannon’s Entropy Equation to rank the complexity, unpredictability, or challenge of the training scenarios, wherein a low entropy score indicates fewer processing elements for completing the training scenarios, and a high entropy score indicates more processing elements for completing the training scenarios.
